(19) United States
(12) Patent Application Publication
(10) Pub. No.: US 2024/0353531 A1
(43) Pub. Date: Oct. 24, 2024

(54) Method and System for Estimating an Object Size Using Range Sensor Detections

(71) Applicant: Aptiv Technologies AG, Schaffhausen (CH)

(72) Inventors: Mateusz Sniegucki, Kraków (PL); Pawel Dyrdon, Zawiercie (PL)

(21) Appl. No.: 18/637,963

(22) Filed: Apr. 17, 2024

(30) Foreign Application Priority Data
Apr. 19, 2023 (EP) 23168699

(51) Int. Cl. G01S 7/41; G01S 7/48; G01S 13/42; G01S 13/931; G01S 17/42; G01S 17/931

(52) U.S. Cl. CPC G01S 7/41; G01S 7/4802; G01S 13/42; G01S 13/931; G01S 17/42; G01S 17/931

(57) ABSTRACT

A computer-implemented method for estimating an object size using range sensor detections detected by a range sensor mounted on a host vehicle. The method includes, for an object detected by the range sensor detections, over time, determining, based on the range sensor detections, pseudo measurements of dimensions of a bounding box enclosing the detected object. The method includes determining estimates for the dimensions of the bounding box, based on respective previous pseudo measurements and current pseudo measurements. The estimates are determined by taking into account a confidence measure for the range sensor detections. The method includes determining the object size based on the determined estimates.

### CROSS-REFERENCE TO RELATED APPLICATIONS

This application claims priority to EP 23 168 699 filed Apr. 19, 2023, the entire disclosure of which is incorporated by reference.

### FIELD

The present application relates to the field of range sensors, and more particular to a method, a system and a computer-readable storage medium for estimating an object size using range sensor detections.

### BACKGROUND

In the field of automotive advanced safety and autonomous driving, range sensors such as LiDAR and radar sensors are employed in order to allow vehicles to perceive their surroundings and to detect objects therein. Detected objects can be tracked, e.g., to estimate an object's position, speed, heading, or size.

Objects that are tracked via detections provided by range sensors may be represented by bounding boxes. The size of a respective bounding box is considered to correspond to the real size, i.e., width and length of a corresponding tracked object.

However, the accuracy of a size estimate for a bounding box of a tracked object suffers when the amount of detections decreases over time, which may result in a shrinking bounding box.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Accordingly, there is a need for improved systems and methods for estimating an object size using range sensor detections while avoiding the above discussed problems.

The invention is defined in the appended independent claims. Advantageous embodiments of the invention are defined in the dependent claims.

One aspect of the present invention relates to a computer-implemented method for estimating an object size using range sensor detections detected by a range sensor mounted on a host vehicle. For an object detected by the range sensor detections, the method comprises the following steps performed over time: determining, based on the range sensor detections, pseudo measurements of dimensions of a bounding box enclosing the detected object; and determining estimates for the dimensions of the bounding box, based on respective previous pseudo measurements and current pseudo measurements, wherein the estimates are determined by taking into account a confidence measure for the range sensor detections; and determining the object size based on the estimates.

By taking into account a confidence measure for the range sensor detections, i.e., by using additional statistical data regarding a confidence for the range sensor detections, the proposed method allows an estimation of the size of a detected object more accurately compared to known approaches. In particular, the invention avoids the above mentioned problems of a fluctuating or shrinking bounding box.

In an embodiment, the confidence measure for the range sensor detections is a measurement uncertainty of each pseudo measurement, wherein the estimates are determined by taking into account the measurement uncertainty of each pseudo measurement.

In a further embodiment, the measurement uncertainty of each pseudo measurement is calculated based on an object distance d of the detected object to the host and an orientation α of the detected object towards the host.

In a further embodiment, the estimates are determined by applying a Kalman filter.

In some embodiments, the range sensor detections include at least one of LiDAR detections, provided by a LiDAR sensor; and radar detections, provided by a radar sensor.

In a further embodiment, the dimensions of the bounding box include a width and a length, wherein the width is defined by distances measured from a reference point relative to a longitudinal axis of the detected object, and wherein the length is defined by distances measured from the reference point relative to a lateral axis of the detected object.

In a further embodiment, the width of the bounding box is defined by a sum of a first width extending, relative to the longitudinal axis, to the left from the reference point and a second width extending, relative to the longitudinal axis, to the right from the reference point. The length of the bounding box is defined by a sum of a first length extending, relative to the lateral axis, to the back from the reference point and a second length extending, relative to the lateral axis, to the front from the reference point.

In a further embodiment, determining the pseudo measurements of the dimensions of the bounding box comprises, over time, determining a pseudo measurement for each of the distances measured from the reference point by expanding each respective distance to the associated respective outer most range sensor detections with respect to the reference point.

According to a further embodiment, the measurement uncertainty of the pseudo measurements of the first and second lengths is defined by

$${r}_{len} = {a}_{l} \cdot \frac{d}{sin ( α )} + {b}_{l}$$

and the measurement uncertainty of the pseudo measurements of the first and second widths is defined by

$${r}_{wid} = {a}_{w} \cdot \frac{d}{cos ( α )} + {b}_{w}$$

wherein αₗ, bₗ, a_{w}, b_{w} are calibration parameters.

In a further embodiment prior to the determining of the pseudo measurements, the method comprises for each pseudo measurement based on a range sensor detection outside the current bounding box, weighting the range sensor detection higher compared to a range sensor detection inside the current bounding box, e.g., by increasing the estimate uncertainty for the respective dimension of the bounding box by a first factor.

In a further embodiment, prior to the determining of the pseudo measurements, the method comprises, if the detected object is at least partly occluded, stopping the determining of estimates until the detected object is no longer occluded, effectively freezing the determining of estimates.

In a further embodiment, prior to the determining of the pseudo measurements, the method comprises, if the detected object is merged with a further object detected by the range sensor detections, increasing, for each of the pseudo measurements of the respective distances measured from the reference point, the respective estimate uncertainty by a second factor.

In a further embodiment, the method further comprises at least one of determining a movement instruction for the host vehicle based on the determined object size; using the determined object size in a path planning or parking aid sub-system of the host vehicle; and using the determined object size for a driving function, wherein the driving function is one of blind spot warning, lane change assist, automatic emergency braking, and evasive steering.

Another aspect of the present invention relates to a system comprising means for performing the steps of the above described method.

Still another aspect of the present invention relates to a computer-readable storage medium comprising instructions which, when executed by a computer, cause the computer to carry out the above described method.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

In order to best describe the manner in which the above-described embodiments are implemented, as well as define other advantages and features of the disclosure, a more particular description is provided below and is illustrated in the appended drawings. Understanding that these drawings depict only example embodiments of the invention and are not therefore to be considered to be limiting in scope, the examples will be described and explained with additional specificity and detail through the use of the accompanying drawings in which:

FIG. 1 illustrates an object tracking scenario;

FIG. 2 illustrates the use of pseudo size measurements based on range sensor detections to estimate the size of an object;

FIG. 3 illustrates a computer-implemented method for estimating an object size using range sensor detections according to the invention;

FIG. 4 illustrates a model of measurement uncertainty according to the invention;

FIGS. 5 and 6 illustrate the use of a Kalman Filter to estimate the size of a detected object according to the invention; and

FIG. 7 illustrates an example scenario with object occlusion.

In the drawings, reference numbers may be reused to identify similar and/or identical elements.

### DETAILED DESCRIPTION

Various embodiments of the disclosed methods and arrangements are discussed in detail below. While specific implementations are discussed, it should be understood that this is done for illustration purposes only. A person skilled in the relevant art will recognize that other components, configurations, and steps may be used without parting from the scope of the disclosure.

FIG. 1 illustrates an object tracking scenario. A host, such as a vehicle, is equipped with a range sensor, such as a LiDAR sensor or a radar sensor. It should be noted that any range sensor may be employed to acquire range detections. The detections allow to track corresponding objects in the surrounding of the host, such as the two vehicles shown in FIG. 1. The goal of object tracking using range sensor detections is to estimate an object's position, speed, heading, and/or size.

As illustrated in FIG. 1, objects that are tracked via detections provided by range sensors may be represented by bounding boxes. The size of a respective bounding box is considered to correspond to the real object size, i.e., width and length of a corresponding tracked object. In FIG. 1, the range sensor detections are illustrated by crosses.

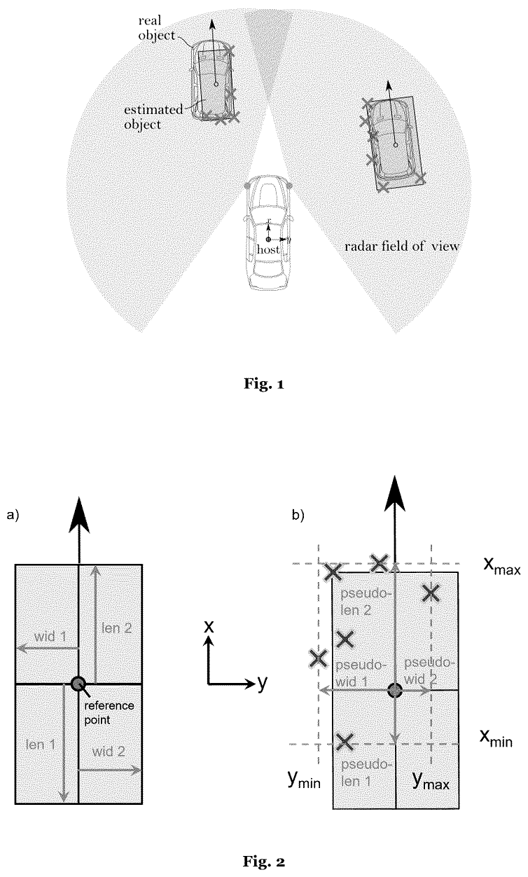

FIG. 2 illustrates the use of pseudo size measurements based on range sensor detections to estimate the size of an object. The size of a detected object may be described by its bounding box, and is represented by four distances wid_1, wid_2, len_1, len_2, as shown in FIG. 2a. The four distances are measured from a predetermined reference point of the object, which defines its position. At every time step of the estimation process, these widths and lengths are the output of the size estimator, such as a Kalman filter.

For estimating the size of a detected object, the bounding box's boundaries are expanded to the outer most associated detections. FIG. 2b shows the respective resulting measured “pseudo-” lengths and widths. These pseudo measurements are used to estimate the size of the respective object.

The resulting estimates may be lowpass filtered over time, which however merely reflects a current spread of detections with additional smoothing rather than representing an estimate of the real object size. As a result, the determined object bounding box may fluctuate. i.e., its width and length may change in value, depending on currently available range sensor detections. Further, the accuracy of a size estimate may suffer when an amount of detections decreases over time, which in turn may result in a shrinking bounding box.

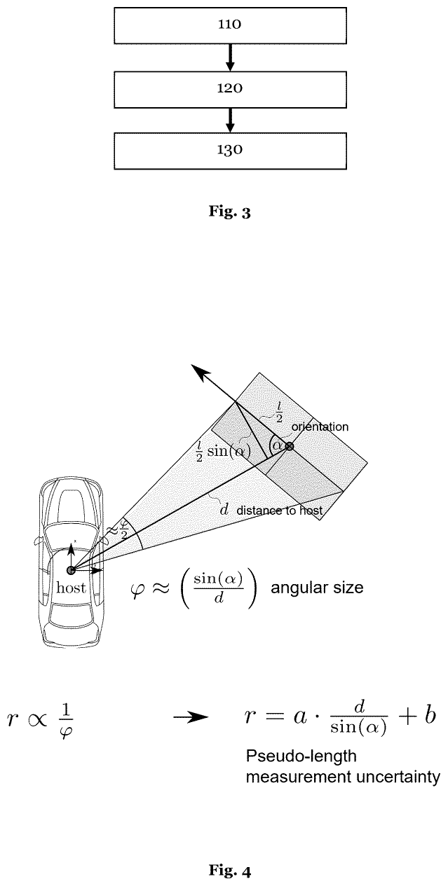

FIG. 3 illustrates a computer-implemented method for estimating an object size using range sensor detections detected by a range sensor mounted on a host vehicle according to the invention. For an object detected by the range sensor detections, the method comprises several steps performed over time. In step 110, pseudo measurements of dimensions of a bounding box enclosing the detected object are determined, based on the range sensor detections. In step 120, an estimation of the dimensions of the bounding box is performed by determining estimates for the dimensions of the bounding box, based on respective previous pseudo measurements and current pseudo measurements, wherein the estimates are determined by taking into account a confidence measure for the range sensor detections. In step 130, the object size is determined based on the estimates.

Advantageously, the confidence measure for the range sensor detections is a measurement uncertainty of each pseudo measurement, such that the estimates are determined by taking into account the measurement uncertainty of each pseudo measurement. Specifically, the measurement uncertainty of each pseudo measurement may be calculated based on an object distance d of the detected object to the host and an orientation α of the detected object towards the host. The estimates may, e.g., be determined by applying a Kalman filter.

As noted above, any range sensor may be employed to acquire range detections, such as LiDAR sensors or radar sensors.

The dimensions of the bounding box include a width and a length, wherein the width is defined by distances measured from a reference point relative to a longitudinal axis of the detected object, and wherein the length is defined by distances measured from the reference point relative to a lateral axis of the detected object.

It should be noted that the reference point may be determined in any suitable manner. For instance, the reference point may represent the object's position and the point of turning around its axis. However, the reference point may be any point within the bounding box. For instance, the reference point may be chosen as the middle point of a vehicle's front bumper or the vehicle's rear axle middle point. The above discussed pseudo measurements are defined relative to the reference point.

As illustrated in FIG. 2a, the width of the bounding box is defined by a sum of a first width wid_1 extending, relative to the longitudinal axis (indicated by the black arrow in FIG. 2a), to the left from the reference point and a second width wid_2 extending, relative to the longitudinal axis, to the right from the reference point. Similarly, the length of the bounding box is defined by a sum of a first length len_1 extending, relative to the lateral axis, to the back from the reference point and a second length len_2 extending, relative to the lateral axis, to the front from the reference point.

According to the invention, determining the pseudo measurements of the dimensions of the bounding box comprises, over time, determining a pseudo measurement for each of the distances wid_1, wid_2, len_1, len_2 measured from the reference point by expanding each respective distance wid_1, wid_2, len_1, len_2 to the associated respective outer most range sensor detections with respect to the reference point. In FIG. 2b, the dashed lines illustrate a temporary bounding box defined by pseudo measurements pseudowid_1, pseudowid_2, pseudolen_1, pseudolen_2 for each of the respective distances wid_1, wid_2, len_1, len_2. These pseudo measurements are the inputs to the estimation performed by the Kalman filter. However, the pseudo measurements are changing in time according to the distance and angle towards the host, and hence, the resulting estimated bounding box which is output by the Kalman filter at the end of the estimation process is an aggregate of the pseudo measurements, wherein the individual pseudo measurements are weighted as discussed below, based on the object's distance and orientation towards the range sensor. It should be noted that the dashed bounding box as illustrated in FIG. 2b could result as the final estimated bounding box provided that the dashed box remains constant during the whole duration of the estimation process.

FIG. 4 illustrates the model of measurement uncertainty according to the invention. As noted above, the measurement uncertainty of each pseudo measurement is calculated based on an object distance d of the detected object to the host and an orientation α of the detected object towards the host. The model of measurement uncertainty illustrated in FIG. 4 is a key ingredient for the estimation performed according to the invention, e.g., by using a Kalman filter.

As illustrated, the model is based on an angular size of edges of the detected object, and an object distance to the host. Hence, according to the invention, the individual pseudo measurements which are used over time as inputs to the estimation performed by the Kalman filter to provide a final estimation of the detected object's size are not always weighted equally, because the pseudo measurements become less accurate the further away the detected object is from the range sensor. Further, the accuracy of pseudo measurements may depend on other factors, e.g., on how much reflective surface a detected object is exposing towards the range sensor. Hence, according to the invention, to enhance accuracy of a size estimate based on the pseudo measurements, the measurement uncertainties r are weighted according to the object's distance d and orientation α towards the range sensor, as discussed in more detail below.

As illustrated in FIG. 4, the visibility of the detected object's length by the range sensor is assumed to be roughly represented by the angular size φ which depends on the orientation α of the object towards the host vehicle and its distance d. The measurement uncertainty r is thus modelled as a reciprocal relationship with the object's angular size φ. Considering the detected object's length, its angular size will be smaller the greater its distance d and the smaller α, i.e., its orientation towards the range sensor. Considering the detected object's width, then the distance has the same influence, but a bigger orientation towards the radar will increase the angular size.

Further with reference to FIG. 4, and regarding the measurement uncertainty r of each pseudo measurement as taken into account by the Kalman filter according to the present invention, the measurement uncertainty rₗₑₙ of the pseudo measurements of the first and second lengths len_1 and len_2 may be defined by

$${r}_{len} = {a}_{l} \cdot \frac{d}{sin ( α )} + {b}_{l}$$

and the measurement uncertainty r_{wid} of the pseudo measurements of the first and second widths wid_1 and wid_2 may be defined by

$${r}_{wid} = {a}_{w} \cdot \frac{d}{cos ( α )} + {b}_{w}$$

wherein αₗ, bₗ, a_{w}, b_{w} may be calibration parameters.

As discussed above, whereas in the case that the pseudo lengths and widths are lowpass filtered to get temporally smooth results, the invention uses a Kalman filter to create mean values taking into account the confidence, or uncertainty, of pseudo measurements. The result is a more accurate estimate that is over time converging to the ground truth.

In particular, the size estimation provided by the Kalman filter according to the invention remains accurate when a detected object moves away from the host vehicle since the estimation performed by the Kalman filter has accumulated enough knowledge about the object's size, while in known approaches the size estimation will deteriorate since it merely reflects current measurements.

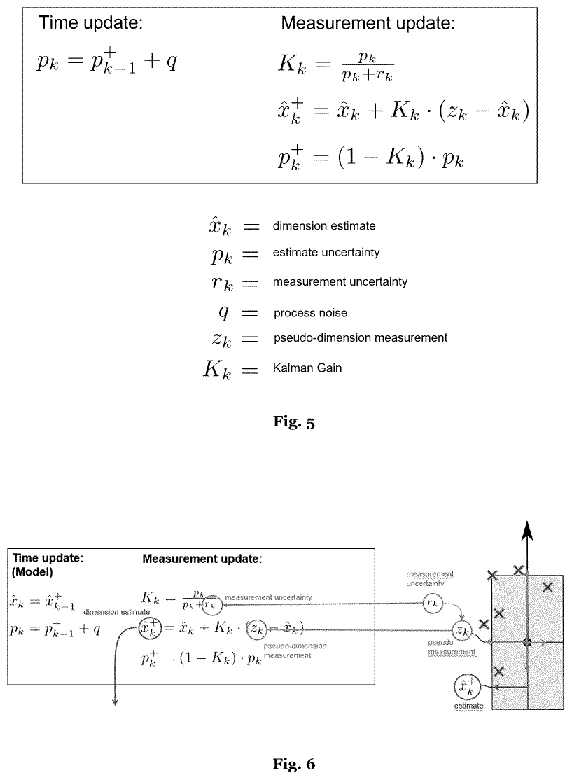

FIGS. 5 and 6 illustrate the use of a Kalman Filter for an estimation of the size of a detected object according to the invention.

FIG. 5 illustrates the main calculations of the Kalman filter. The invention uses the Kalman Filter to gain estimates \hat{x}ₖ with low uncertainty pₖ by accumulating dimension information collected in the form of pseudo measurements zₖ over several time steps k. This is possible because the uncertainty rₖ of a respective pseudo measurement, which depends on the distance d and orientation of the object, is provided in the invention as the above described model, which describes how much each respective pseudo measurement should impact the size estimate at any given time instance of the estimation process performed by the Kalman filter.

FIG. 6 illustrates the recursive adding of new information to improve a size estimation for a detected object based on range sensor detections using a Kalman filter according to the invention.

According to further embodiments, prior to the main measurement update loop, i.e., during each time step k of the estimation process performed by the Kalman filter, preceding actions may be taken to achieve more accurate estimates. Examples for such preceding actions are discussed in the following.

According to one embodiment, prior to the determining of the pseudo measurements, the method comprises compensating measurement bias.

Measurement bias stems from a distribution of radar detections across the whole detected object's geometry. Since radar detections that lie beyond the object's outer delimiting surface do not represent the object's outer dimensions, compensation of measurement bias may effectively suppress these biased detections. More specifically, the mean spread of detections (relative from the center), i.e., the mean pseudo width and length over time is biased towards smaller values because if the target is for instance a vehicle, a large amount of detections is reflected not only from the target vehicle's outside but also from its cabin inside, underbody, etc. It should be noted that this is the main contribution to the spread, not the measurement noise.

In order to compensate for this bias, the estimate uncertainty pₖ is reset to higher values whenever a pseudo measurement (pseudo width or pseudo length respectively) is greater than the current estimate (pseudo width or pseudo length respectively), that is when the detection is outside of the currently estimated bounding box. This can be formulated as follows:

if (pseudowid>current wid)

$${p}_{k} = {p}_{k} + Δ p$$

Hence, because there is a bias in the pseudo measurements towards smaller values, detections outside the current bounding box estimate are weighted higher by incrementing the estimate uncertainty pₖ of the respective dimension. Accordingly, in an embodiment, compensating measurement bias comprises, for each pseudo measurement based on a range sensor detection outside the current bounding box, increasing the estimate uncertainty pₖ for the respective dimension of the bounding box by a first factor Δp.

Generally, the estimate uncertainty pₖ over time decreases when accumulating detections, i.e., the estimator, i.e., the Kalman filter performing the estimation, is increasingly confident of the size estimate. New detections, e.g., from the target vehicle's surface, would have a low impact on the current estimation since already a lot of detections from, e.g., the vehicle cabin have contributed to the estimation. Therefore, resetting the estimate uncertainty pₖ whenever a new detection exceeds the value of the current estimate allows the estimator to take this detection more strongly into account and to adjust the estimation towards that outer detection. Eventually no more outer detections occur since the estimation will have increased so that every new detection will likely be inside the bounding box.

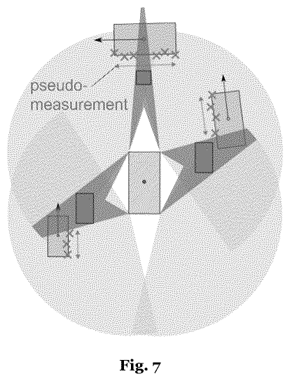

FIG. 7 illustrates an example scenario with object occlusion. According to a further embodiment, the method comprises handling such occlusions. Occlusions are blockages in the field of view of the host's radar by an occluding object that occludes the object whose size is to be estimated. For instance, if the detected object is at least partly occluded, the determining of estimates, e.g., performed by the Kalman filter, is stopped until the detected object is no longer occluded. Effectively, the determining of estimates is frozen in that situation. In other words, the measurement update is disabled for objects that are partly or fully occluded because pseudo measurements do not reflect the whole length or width of the object in such a case. Stopping the estimation for the respective estimation cycle and effectively freezing the current estimates until the occlusion is removed prevents the occlusion to affect the size estimation of the detected object.

As an alternative or additional preceding action, in a further embodiment, the method comprises handling of merged objects prior to the determining of the pseudo measurements. Merging two objects without adjusting the merger's size can lead to size overestimation. Merging implies new data is available, therefore the estimate uncertainty pₖ is increased to allow for size adjustment based on new data. This can be formulated as follows:

$${p}_{k} = c \cdot dim$$

with c ∈[0,1] and dim E {len_1, len_2, wid_1, wid_2}. Hence, according to the invention, if the detected object is merged with a further object detected by the range sensor detections, for each of the pseudo measurements of the respective distances measured from the reference point the respective estimate uncertainty pₖ is increased by a second factor c.

The present invention allows for a more accurate estimation of the object size using range sensor detections. In particular, the present invention avoids the determining of fluctuating and especially shrinking bounding boxes for detected objects. Further, the invention allows a more stable bounding box edge alignment with respect to ground truth. Generally, the problem of a fluctuating object bounding box, i.e., when its width and length changes in value, depending on currently available range sensor detections is solved by using additional statistical data, e.g., confidence values for the range sensor detections and employing an estimation method that utilizes this information in an optimal way to estimate the size of a detected object more accurately. For instance, when estimating an object length for an object that is being overtaken by a host vehicle, while the estimated length according to known approaches may fluctuate with the current distribution of detection points, the estimation according to the invention converges towards the ground truth value. In particular, and in contrast to the invention, known approaches do not rely on a model of measurement uncertainties, which however allows to achieve more accurate and particularly non-fluctuating estimation results regarding the bounding box of a detected object.

The present invention may be useful in many applications of automotive advanced safety and autonomous driving. For instance, knowledge of the size of an object may be useful in the perception of the environment around a vehicle, and generally in any driving functions that rely on that perception, such as, e.g., blind spot warning, lane change assist, automatic emergency braking, evasive steering, etc. The more accurate the size estimate is, the more precise the driving functions using this knowledge can be. Further, the invention may be used in determining a movement instruction for a vehicle based on the determined object size of a detected object. The determined object size may also be used in a path planning or parking aid sub-system of the host vehicle.

The various embodiments described above are provided by way of illustration only and should not be construed to limit the invention. Those skilled in the art will readily recognize various modifications and changes that may be made to the present invention without following the example embodiments and applications illustrated and described herein, and without departing from the scope of the present disclosure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The invention claimed is:

1. A computer-implemented method for estimating an object size using range sensor detections detected by a range sensor mounted on a host vehicle, the computer-implemented method comprising:
for an object detected by the range sensor detections, over time:
determining, based on the range sensor detections, pseudo measurements of dimensions of a bounding box enclosing the detected object;
determining estimates for the dimensions of the bounding box based on respective previous pseudo measurements and current pseudo measurements, wherein the estimates are determined based on a confidence measure for the range sensor detections; and
determining the object size based on the determined estimates.

2. The computer-implemented method of claim 1 wherein:
the confidence measure for the range sensor detections is a measurement uncertainty of each pseudo measurement, and
the estimates are determined based on the measurement uncertainty of each pseudo measurement.

3. The computer-implemented method of claim 2 wherein the measurement uncertainty of each pseudo measurement is calculated based on an object distance of the detected object to the host vehicle and an orientation of the detected object towards the host vehicle.

4. The computer-implemented method of claim 1 wherein the estimates are determined by applying a Kalman filter.

5. The computer-implemented method of claim 1 wherein the range sensor detections include at least one of:
LiDAR detections provided by a LiDAR sensor; or
radar detections provided by a radar sensor.

6. The computer-implemented method of claim 1 wherein:
the dimensions of the bounding box include a width and a length,
the width is defined by distances measured from a reference point relative to a longitudinal axis of the detected object, and
the length is defined by distances measured from the reference point relative to a lateral axis of the detected object.

7. The computer-implemented method of claim 6 wherein:
the width of the bounding box is defined by a sum of a first width extending, relative to the longitudinal axis, to the left from the reference point and a second width extending, relative to the longitudinal axis, to the right from the reference point, and
the length of the bounding box is defined by a sum of a first length extending, relative to the lateral axis, to the back from the reference point and a second length extending, relative to the lateral axis, to the front from the reference point.

8. The computer-implemented method of claim 6 wherein the determining of the pseudo measurements of the dimensions of the bounding box includes, over time:
determining a pseudo measurement for each of the distances measured from the reference point by expanding each respective distance to an associated respective outer most range sensor detections with respect to the reference point.

9. The computer-implemented method of claim 1 further comprising, prior to the determining of the pseudo measurements:
for each pseudo measurement based on a range sensor detection outside the current bounding box weighting the range sensor detection higher compared to a range sensor detection inside the current bounding box.

10. The computer-implemented method of claim 9 wherein the range sensor detection outside the current bounding box is weighted higher compared to a range sensor detection inside the current bounding box by increasing an estimate uncertainty for the respective dimension of the bounding box by a first factor.

11. The computer-implemented method of any of claim 1 further comprising, prior to the determining of the pseudo measurements:
in response to the the detected object being at least partly occluded, stopping the determining of estimates until the detected object is no longer occluded to freeze the determining of estimates.

12. The computer-implemented method of claim 6 further comprising, prior to the determining of the pseudo measurements:
in response to the detected object being merged with a further object detected by the range sensor detections, increasing, for each of the pseudo measurements of the respective distances measured from the reference point, a respective estimate uncertainty by a second factor.

13. The computer-implemented method of claim 1 further comprising at least one of:
determining a movement instruction for the host vehicle based on the determined object size;
using the determined object size in a path planning or parking aid sub-system of the host vehicle; or
using the determined object size for a driving function, wherein the driving function is one of: blind spot warning, lane change assist, automatic emergency braking, or evasive steering.

14. A system for estimating an object size using range sensor detections detected by a range sensor mounted on a host vehicle, the system comprising:
memory hardware configured to store instructions; and
processor hardware configured to execute the instructions, wherein the instructions include:
for an object detected by the range sensor detections, over time:
determining, based on the range sensor detections, pseudo measurements of dimensions of a bounding box enclosing the detected object;
determining estimates for the dimensions of the bounding box based on respective previous pseudo measurements and current pseudo measurements, wherein the estimates are determined based on a confidence measure for the range sensor detections; and
determining the object size based on the determined estimates.

15. A non-transitory computer-readable medium comprising instructions including:
for an object detected by range sensor detections, over time:
determining, based on the range sensor detections, pseudo measurements of dimensions of a bounding box enclosing the detected object,
determining estimates for the dimensions of the bounding box, based on respective previous pseudo measurements and current pseudo measurements, wherein the estimates are determined by taking into account a confidence measure for the range sensor detections, and
determining an object size based on the determined estimates.
